(19) United States
(12) Patent Application Publication
(10) Pub. No.: US 2025/0139961 A1
(43) Pub. Date: May 1, 2025

(54) Self-Annotated Method And System For Removing Smeared Points

(71) Applicant: Board of Trustees of Michigan State University, East Lansing, MI (US)

(72) Inventors: Daniel MORRIS, Okemos, MI (US); Miaowei WANG, East Lansing, MI (US)

(73) Assignee: Board of Trustees of Michigan State University, East Lansing, MI (US)

(21) Appl. No.: 18/928,440

(22) Filed: Oct. 28, 2024

Related U.S. Application Data
(60) Provisional application No. 63/546,672, filed on Oct. 31, 2023.

(51) Int. Cl. G06V 10/98; G06T 7/55; G06T 17/00; G06V 10/764; G06V 10/774; G06V 20/70

(52) U.S. Cl. CPC G06V 10/993; G06T 7/55; G06T 17/00; G06V 10/764; G06V 10/774; G06V 20/70; G06T 2210/56

(57) ABSTRACT

A method and system for removing smeared pixels from an image includes obtaining a plurality of training images of a scene from different poses, forming a point cloud of the scene having a plurality of pixels and a depth, and rendering a first pixel in a first reference frame to a second reference frame. The method includes comparing a depth difference of the first depth and the second depth, determining whether the pixel is valid or smeared based on the depth difference, associating a label with the pixel corresponding to valid or smeared, training a classifier with the pixel and the label to form a trained classifier, obtaining an image to be classified at the classifier and classifying the pixels in the image as valid or smeared and removing smeared pixels from the image to form a cleaned image.

### CROSS-REFERENCE TO RELATED APPLICATIONS

This application claims the benefit of U.S. Provisional Application No. 63/546,672, filed on Oct. 31, 2023. The entire disclosure of the above application is incorporated herein by reference.

### FIELD

The present disclosure relates to a method and system for removing smear points in image processing.

### BACKGROUND

This section provides background information related to the present disclosure which is not necessarily prior art.

While dense depth sensors have led to dramatic improvements in 3D computer vision tasks, including alignment, classification, and reconstruction, they nevertheless still suffer from depth artifacts which can harm performance. Factors including scene complexity, hardware device conditions and sensor motion can adversely impact depth. Fortunately, consumer-level depth sensors have improved over the years, with long-standing problems such as Gaussian noise, shot noise and multi-path interference being alleviated. However, there continues to exist an important class of invalid depth points at the boundaries of objects called smeared points. Smeared points are points not on any 3D surface and typically occur as interpolations between foreground and background objects. As they cause fictitious surfaces, these points have potential to harm applications dependent on the depth maps. Statistical outlier removal methods fare poorly in removing these points as they tend to also remove actual surface points. Trained network-based point removal faces difficulty in obtaining sufficient annotated data. The points often interpolate between objects across depth discontinuities, and so call them smeared points, in contrast to other outliers or random noise. Eliminating smeared points without harming other depth points, especially valid boundary details is desirable.

A primary cause of smeared points is multi-path reflections. Pixels on or adjacent to edge discontinuities can receive two or more infrared signal reflections; one from the foreground object and one from the background. Depending on the sensor circuitry, these multiple returns can result in a variety of artifacts and typically they will result in interpolated depths between the foreground and background object. The smeared points can be problematic for applications that use depth maps as they result in false surfaces in virtual worlds, blurring of fine 3D structure and degraded alignments between point clouds. These harms are compounded when multiple point clouds each having different artifacts are combined into an overall blurred point cloud.

Now, improvements in sensor processing have given modern sensors the ability to remove some of these smeared points, particularly when there is a large gap between the foreground and background objects. Nevertheless, smearing smaller depth discontinuities is not solved due to the difficulty in distinguishing occlusion effects from complex shape effects, and as a consequence smeared points continue to plague the otherwise high quality depth images. A variety of hand-crafted filters can be used to reduce noise in depth maps, but they perform poorly in removing smeared points or else result in overly smoothed surfaces. A data-driven approach would be preferable, but these face the difficulty of acquiring sufficient ground truth which is expensive and time consuming to obtain.

Another approach is to create synthetic datasets with known ground truth, but these are limited by how well they model both the sensing and the environment. Unsupervised domain adaptation can address this to some extent. Besides, approaches using multiple different frequencies on the same position, and using the shooting equipment with multiple cameras create more acquisition overhead and inconvenience.

### SUMMARY

This section provides a general summary of the disclosure, and is not a comprehensive disclosure of its full scope or all of its features.

The contributions of the present disclosure include a fully automated annotation technique for smeared points that applies geometric consistency to multi-frame data collections. By combining automated annotation with a pixel-level discriminator, a self-annotated smeared point detector is created. The present disclosure introduces a new synthetic Azure Kinect dataset as a benchmark for multiple tasks. The design choices are validated using several ablations.

The present disclosure overcomes the difficulty in acquiring ground truth data for hand-held depth sensors by developing a novel self-annotated method for eliminating smeared points. This avoids the need for building complex optical sensing models, and it also eliminates the need for expensive manual annotations of data. Instead, the present system and method leverages the dense depth sensing capabilities of these sensors, along with multi-view consistency model to automatically self-annotate points. In this way, data can be rapidly acquired without human annotation and used to train a smeared-point remover.

In one aspect of the disclosure, a method for removing smeared pixels from an image includes obtaining a plurality of training images of a scene from different poses, forming a point cloud of the scene having a plurality of pixels and a depth, and rendering a first pixel in a first reference frame to a second reference frame. The method includes comparing a depth difference of the first depth and the second depth, determining whether the pixel is valid or smeared based on the depth difference, associating a label with the pixel corresponding to valid or smeared, training a classifier with the pixel and the label to form a trained classifier, obtaining an image to be classified at the classifier and classifying the pixels in the image as valid or smeared and removing smeared pixels from the image to form a cleaned image.

In another aspect of the disclosure, a method for removing smear points in image processing includes obtaining a plurality of images of a scene from different poses of an imaging device, wherein the plurality of images has a plurality of pixels, determining whether each of the pixels is valid or smeared based on multi-viewpoint evidence; annotating a valid label or smeared label to each of the pixels to form an annotated training set based on determining whether each of the pixels is valid or smeared, training a classifier with the annotated training set to form a trained classifier, communicating an image to classify to the trained classifier, classifying the pixels in the image as valid or smeared and removing smeared pixels from the image to form a cleaned image.

In another aspect of the disclosure, a system includes at least one imaging device generating a plurality of images of a scene from different poses. A pixel annotator forms a point cloud of the scene having a plurality of pixels of each image and a depth, the pixel annotator rendering a first pixel in a first reference frame to a second reference frame. The first reference frame comprising a first depth and the second reference frame comprising a second depth. The pixel annotator comparing a depth difference of the first depth and the second depth, determining whether the pixel is valid or smeared based on the depth difference, associating a label with the pixel corresponding to valid or smeared. The trained classifier trained by with the pixel and the label to form a trained classifier, the trained classifier obtains an image to be classified and classifying the pixels in the image as valid or smeared and removing smeared pixels from the image to form a cleaned image.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1D is an example of a recorded scene having a plurality of smear points according to the present disclosure;

FIG. 2A is a block diagrammatic view of the system of the present disclosure;

FIG. 2B in a schematic flow chart of a method for removing smear points according to the present disclosure;

FIG. 2C is a flow chart of a method for operating the same;

FIG. 3A is an illustrative image of a non-boundary evidence according to the present disclosure;

FIG. 3B is an illustrative image of positive evidence (see through behind) according to the present disclosure;

FIG. 3C is an illustrative image of negative evidence (see through empty according to the present disclosure;

FIG. 3D is a table illustrating for finding inferences from multi-view consistency;

FIG. 4 an algorithm for operating the system;

FIG. 5 is 3 different views of the same scene illustrating depth normal;

FIG. 6 is a table illustrating properties of different data sets;

FIG. 7 is a table illustrating results of the dataset of the present disclosure used in different methods;

FIG. 8 is various views of results on the dataset of the present disclosure;

FIG. 9 is a graph of geometric labels generated from different frames;

FIG. 10 is a table od results with UNet with different inputs;

FIG. 11 is a is an example of images of predicted results with different sliding windows according to the present disclosure;

FIG. 12 is an example results of images using a trained network according to the present disclosure.

Corresponding reference numerals indicate corresponding parts throughout the several views of the drawings.

### DETAILED DESCRIPTION

Example embodiments will now be described more fully with reference to the accompanying drawings.

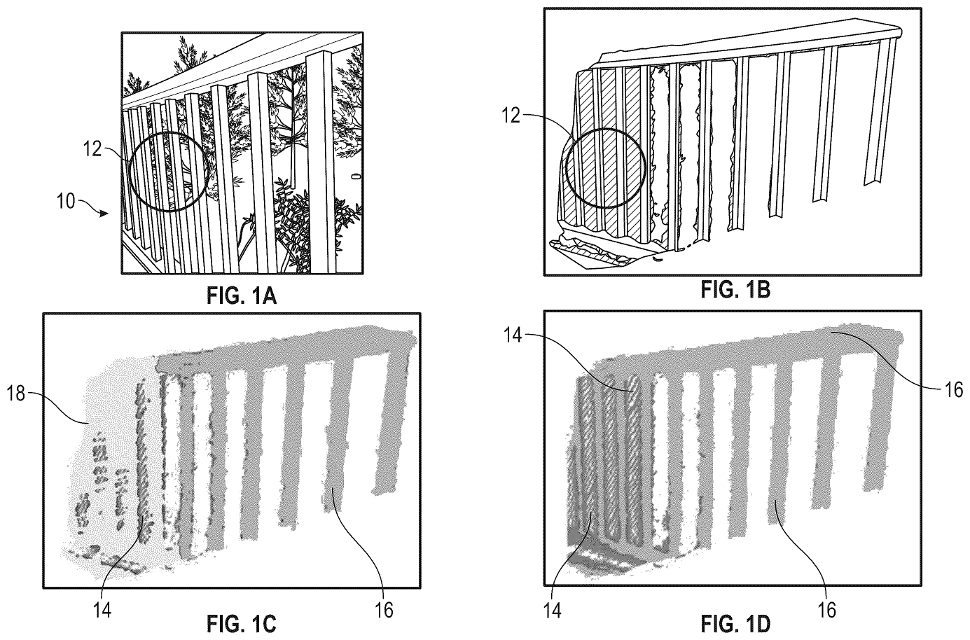

Referring now to FIGS. 1A-1D, an example scene 10 recorded with an Azure Kinect sensor with smeared points is set forth. While Azure Kinect is provided as an example of an image sensor with a depth field, the present disclosure applies to other types of camera or sensing devices that provide images and distance. Orbbec Femto Bolt is one such example. Distance may be determined by Time of Flight (ToF) techniques for each pixel. Cropped color is shown by grey scale shading in FIG. 1A. A side view of the 3D point cloud is in FIG. 1B. Significant smearing can be seen between the vertical columns in the circles 12. In FIG. 1C, the present system and method uses multiple viewpoints to automatically annotate smeared points 14 from valid points 16 and left uncertain points 18. Once trained, the present system and method classifies pixels in a single frame as smeared 14 or valid 16 in FIG. 1D recorded by the Azure Kinect sensor. In FIGS. 1A-1D significant smearing can be seen between the vertical columns. The present system and method discriminate smeared points 14 from valid points 16, generating a final colorized point cloud with only valid points in FIG. 1D.

In order to evaluate this method, a number of different real scenes both indoors and outdoors have been collected and a new Azure Kinect-like plant synthetic dataset is also introduced as another benchmark. Comprehensive experiments on these datasets and ablation studies further demonstrate an example in this disclosure that multi-frame self-supervision can effectively train a smeared point remover.

A method and system for removing smear points in image processing is set forth. In the present disclosure, a method and system are provided that divides the smeared point removal into two distinct components: (1) a pixel annotator and (2) a pixel classifier. Advances in correcting depth offsets have led to high quality depth estimates for the majority of depth pixels, leaving a typically small fraction of invalid or smeared pixels. With these pixels often having large errors, the method herein identifies the smeared pixels for removal rather than seeking to correct their depth. One advantage in using this method includes using an automated smeared-pixel annotation method a less time intensive and cost effective way to obtain a sufficient amount of annotated data that is used to train a supervised single-frame smeared pixel classier, which is used to remove the smeared points.

In addition, the present disclosure provides a fully self-annotated method to train a smeared point removal classifier. The system and method provided herein relies on gathering 3D geometric evidence from multiple perspectives to automatically detect and annotate smeared points and valid points. To validate the effectiveness of the present method, the present disclosure presents two benchmark datasets: a synthetic plant 3D dataset and real Azure-Kinect dataset. Experimental results and ablation studies show that this method outperforms traditional filters and is comparable to supervised competitors.

Obtaining noise-free, dense depth from raw, low-quality measurements has always received significant attention. Before the rise of data-driven techniques, especially deep learning, numerous hand-crafted filters were designed to alleviate noise by referencing neighboring pixels, such as median filter, Gaussian filter, Bilateral filter, and others. Early work to remove outliers introduced density-based and statistical methods, while geometric and photometric consistency between depth maps and color images was also used to detect outliers. As for time-of-flight multipath interference (MPI), multiple different modulation frequency measurements of same scene are collected to improve depth quality. However, in this method, only single-frequency depths map is required and no longer needs to measure a scene multiple times at different frequencies.

Even before deep learning techniques were widely adopted, convolution and deconvolution techniques were proposed to recover time profiles only using one modulation frequency. DeepToF (Deep Time of Flight) processing uses autoencoder to correct measurements based on the observation that image space can provide most of sources for MPI. Continuing the classical multi-frequency method, a multi-frequency ToF camera is integrated into network design to preserve small details based on two sub-networks. RADU updates depth values iteratively along the camera rays by projecting depth pixels into a latent 3D space. These supervised learning methods heavily rely on synthetic datasets generated by a physically-based, time-resolved renderer that uses bidirectional ray tracing which is much time-consuming to render one realistic depth map. In order to shrink the gap between real and synthetic dataset, DeepToF learns real data's statistical knowledge by auto-learning encoders while RADU applies unsupervised domain adaptation by investigating a cyclic self-training procedure derived from existing self-training methods for other tasks. Additionally, an adversarial network framework can be used to perform unsupervised domain adaptation from synthetic to real world data. All these methods depend on the reliability of the simulated dataset. Moreover, current self-annotated denoising methods either require a setup of multiple sensors placed in precomputed different view positions based on photometric consistency and geometric priors or build noise models by assuming noisy points follow some random distribution around normal points which leads to low availability when processing real scenes. In contrast to these approaches, the method operates in a self-annotated manner directly on real scene data without relying on complex scene formation models or on specific noise models or on synthetic datasets.

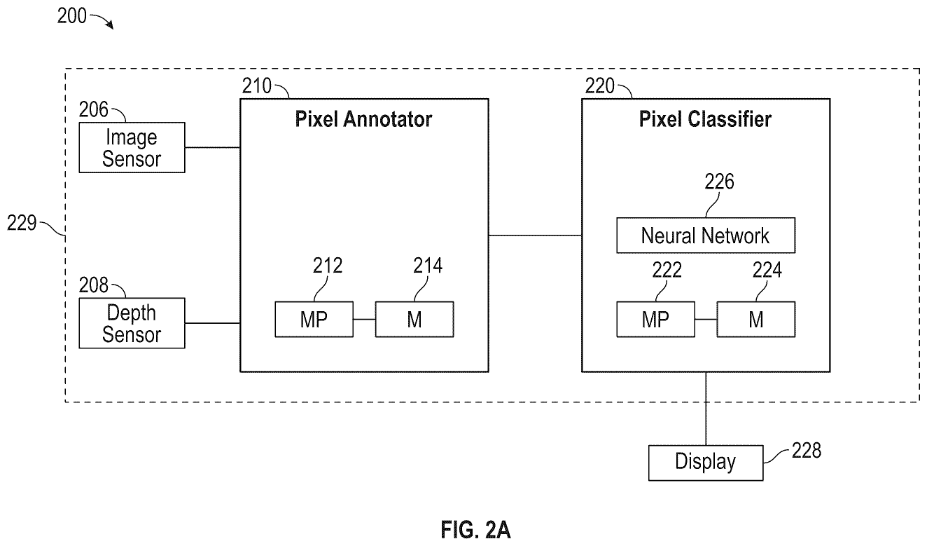

Referring now to FIGS. 2A, 2B and 2C, a system 200 for removing smeared points is set forth. The system 200 includes an image sensor 206 and a depth sensor 208 that generate images 230 each having a plurality of pixels and a depth map for each of the pixels respectively. The sensors may be part of an imaging system. The sensors 206 and 208 are coupled to two distinct components of the smeared point removal system: a pixel annotator 210 and a pixel classifier 220. The pixel annotator 210 is a microprocessor or processor 212 and a memory 214. The processor 212 is microprocessor based. The memory 214 is a non-transitory computer-readable medium including machine-readable instructions that are executable by the processor 212. The pixel classifier 220 is a microprocessor or processor 222 and a memory 224. The processor 222 is microprocessor-based. The memory 224 is a non-transitory computer-readable medium including machine-readable instructions that are executable by the processor 222. Pixel classifier 220 has a neural network 226 that is used for removing smeared points from an image as will be described in greater detail below. Using the supervised architecture, training scenes are recorded with the sensor in step 280. Point cloud formation component 232 forms a three-dimensional point cloud from the two-dimensional image using both the image position and depth from the sensors 206, 208 in step 282 Next, multi-frame pose estimation component 234 aligns the frames in 284. That is, because multiple positions of the sensors 206, 208 are used, the frames are aligned. The images in the frames the from the various poses or positions and the pixels therein are rendered in the rendering component 236 in step 286. Geometric evidence generated at the geometric evidence component 238 in step 288 is then used to annotate each pixel in step 290 as a smeared pixels, valid pixels, for all frames. In addition to the geometric evidence, depth normals are generated for each pixel in step 292. Using the geometric evidence and the depth normals, a U-Net-based classifier or neural network 226 is trained at the trainer 244 in step 294 to form a trained classifier to identify smeared points in each individual frame. Unprocessed images having pixels with positions, depths and depth normals generated at the depth normal generator 240 are then processed with the trained processor in step 296. A processed or cleaned image is communicated to and displayed on a display 228 in step 298 with smeared pixels removed. The sensors, the pixel annotator 210 and the pixel classifier may be incorporated into an imaging system sensor housing 229 such as a camera housing.

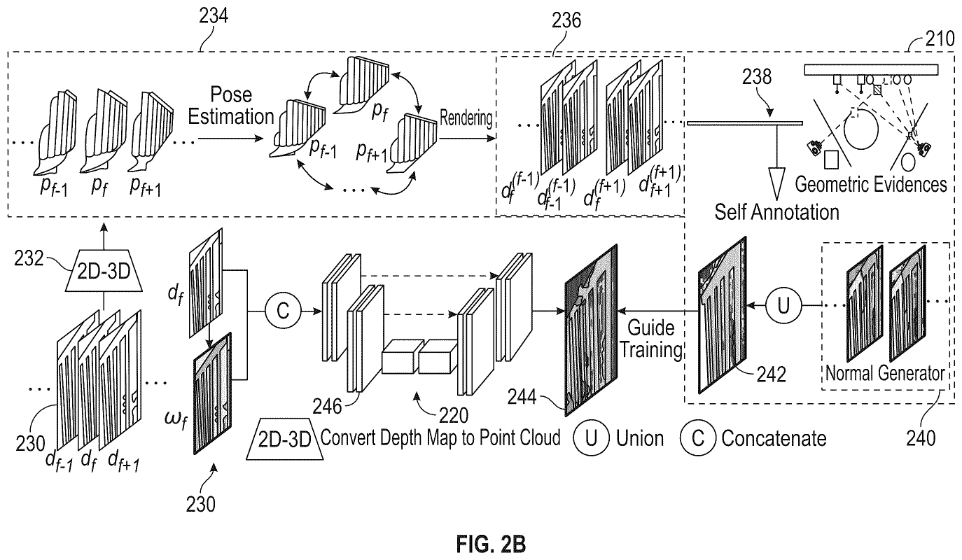

Referring now to FIGS. 3A-3D, geometric evidence is explained by way of illustration. The annotation process is also described. Typically, smeared pixels occur between objects along rays that graze the foreground object. As the viewpoint changes, the grazing rays change orientation and the resulting location of any interpolated points along these rays will also change. On the other hand, 3D points on objects will remain consistent, or at least overlap, between differing viewpoints. Consequently, if a pixel has been observed from multiple viewpoints with differing rays, the pixel must be a valid surface pixel and not a smeared point.

An example of multi-viewpoint evidence is shown in FIG. 3A. Points vA(i) and vA(j) are observed from separate viewpoints A and B and thus determined to be valid points. Now if the distance between viewpoints is small or the distance to the pixels is large, smeared pixels can coincide spatially. To avoid this, the angle θ, always less than 90°, is used between the viewing rays of coincident points as a confidence measure in a point that is valid, and the confidence score c can be modeled as Eq. (1):

$$c = {sin}^{2} ( θ ) \qquad ( 1 )$$

The normalization is applied to the confidence score c to be in the range between 0 and 1. FIG. 3D validates this process.

The second category of evidence gathered has to do with space carving. Smeared points, by definition, float off the surface of objects. Now if a ray measuring a depth pixel passes through the location of a 3D point, then this is evidence that that pixel is not actually at that location but most likely a smeared pixel.

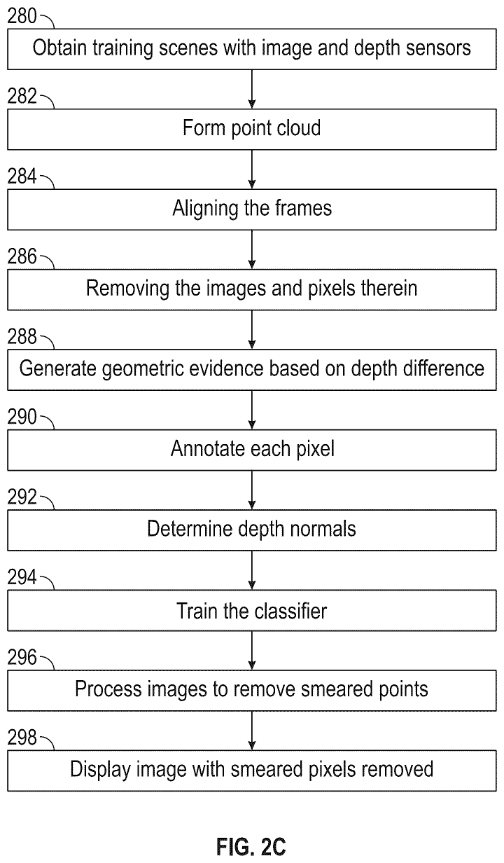

See-through evidence for smeared points is divided into a case of positive evidence (See-through Behind) in FIG. 4B and negative evidence (See-through Empty) in FIG. 4C. In both cases, a point is concluded to be a smeared point if another viewpoint can see through it. In the first case, FIG. 4B, a ray γ_{B} from the camera at location B passes through a point s_{A}(i), observed from location A, and measures a point behind s_{A}(i), from which it can be concluded s_{A} (i) is a smeared point. In the second case FIG. 4C, a point s_{A}(j) observed by A should be visible to viewpoint B, and yet there is no measurement along the ray γ_{B}, either closer or farther than s_{A} (j). To conclude from this negative evidence that s_{A} (j) is a smeared point, the ray γ_{B} is expanded between the sensor and s_{A} (j) to a conical section with angle φ and require no points are observed from B within this, which eliminates the case of grazing rays being blocked and incorrectly inferring a smeared point behind them. The conical section angle φ is a regularization term in See-Through Empty and larger values mean fewer detected smeared points with higher confidence. A naive quick equivalent implementation of φ is applying a sliding window in the depth map. No reference points around the detected smeared point in a larger window size mean higher φ. A sliding window with size 3×3 is used to filter unconfident self-annotated smeared labels in See-through Empty. Ultimately, the depth or distances of the pixels are used to determine whether they are see-through as described in greater detail below. The pixels are determined to be valid or invalid based on the distances or depths.

The three categories of evidence mentioned above for valid and smeared pixels can be summarized herein. It is noted that pixels for which none of the three evidences apply will have an unknown categorization. In order to convert geometric evidences among multiple frames to geometric labels trained for network. It is assumed that a depth sensor is moved around a rigid scene, typically by hand, and gathers depth frames {df−m//2, . . . , df+m//2} from m+1 viewpoints, and from which 3D point clouds {pf−m//2, . . . , pf+m//2} are created. Then the first step is to align all viewpoints as mentioned in step 284 above, which is achieved by multi-frame Iterative Closest Point (ICP). The result of this alignment is a single point cloud and an array of sensor viewpoints. A rendering strategy is utilized here to implement the present ray-tracing model per the table in FIG. 3D. Applying geometric evidence requires visibility reasoning for all pixels, which is performed using rendering. A pixel observed in frame f is denoted as pf with coordinates (uf, vf) and depth df. Because all camera poses are known, the pixel can be projected into any other frame f′, represented as p(f) with coordinates (u_{f′}^{(f′)}, v_{f}^{(f′)} and depth d_{f}^{(f′)}. This defines a mapping from original pixel coordinates to coordinates in any other camera:

$$I : ( {u}_{f} , {v}_{f} ) \to ( {u}_{f}^{( {f}^{′} )} , {v}_{f}^{( {f}^{′} )} ) \qquad ( 2 )$$

Additionally, due to differences between rendered depth map and raw depth map captured by real camera, point cloud pB should also be reprojected to the depth map d_{f}^{(f′)} with the same renderer of d_{f}^{(f′)}.

Referring now to FIG. 4, the geometric evidence can be gathered into three binary variables for each pixel {v_{f}, b_{f}, e_{f}} with each taking values [0, 1]. Here v_{f}=1 indicates valid pixel evidence as it is viewed in multiple frames as in FIG. 4A, while b_{f}=1 indicates smeared pixel evidence due to See-Through Behind in FIG. 4B, and e_{f}=1 indicates smeared pixel evidence due to See-Through Empty as in FIG. 4C. These are summarized in the table of FIG. 3D.

Finally, based on the all above information, a multi-frame geometric generation algorithm is completed in FIG. 4. In this algorithm, pixels observed in a target frame f are labeled a “valid” label or “smeared” label by doing a pairwise comparison or difference of rendered depths, (d_{f}^{(f′)}, d_{f}^{(f′)}, in each of the other reference frames, f′. When the depth difference difference in the depth is about the (within a low threshold E close to zero), the pixel is valid. When the difference is less than −δ (where delta is a threshold), see-through behind is indicated. The number of used reference frames per sequence, m, can be varied, although here m=4 was used, which enabled good multi-frame alignment. A multi-frame annotation can be used on its own to remove smeared points. However, it leaves a significant fraction of points unannotated or unlabeled (85% in the AzureKinect training sets used). Relying on this also requires static frames and camera motion and creates latency. Thus, we use the annotation to train a single-frame network to do the eventual smeared point detection.

Surface normals are mentioned above relative to step 292. The surface normals can be computed efficiently and directly from depth maps by the normal generator 240. The present disclosure specifies that the normal vector n(u, v) at a pixel location (u, v) in depth map d. This normal can be specified as the perpendicular to a facet connecting the 3D pixel p(u, v) and its neighbor pixel location. In order to reflect difference between ray angle and surface, a process is conducted to get an angle value as Eq. (3):

$$ω ( u , v ) = n ( u , v ) T \frac{p ( u , v )}{‖ p ( u , v ‖} \qquad ( 3 )$$

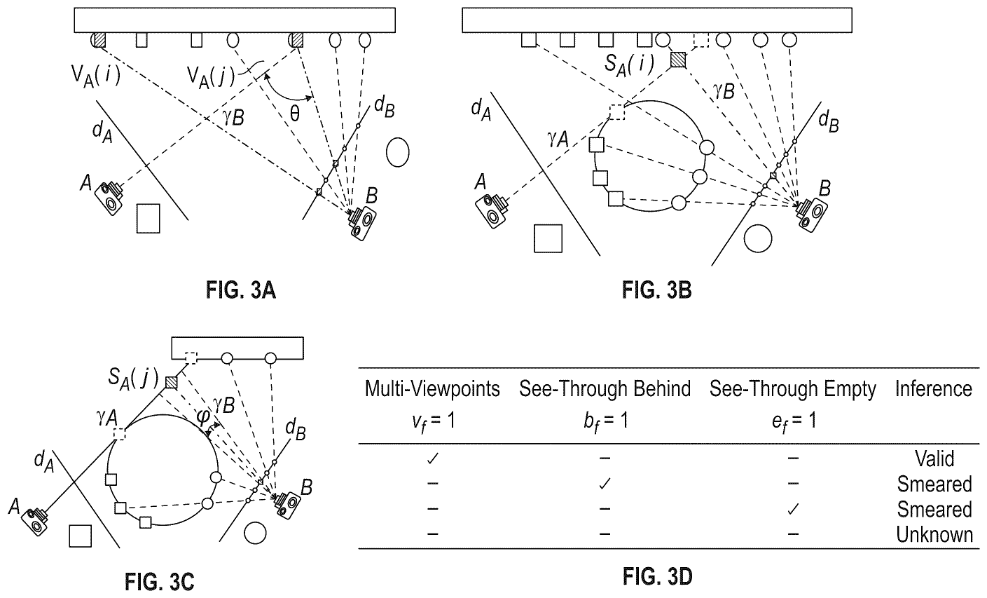

With above equations, a new map ω is generated totally from d and camera intrinsic information as shown in FIG. 5. FIG. 5 provides a comparison of a visualization between the normal-view on an indoor scene and values of the boundary are lower compared to non-boundary areas. An ω of 1 indicates a surface perpendicular to the viewing ray, while an ω of 0 indicates an orthogonal surface.

The training of the classifier 246 is described in greater detail. Some off-the-shelf 2D-based segmentation network is adapted here as the present smeared classifier rather than a 3D segmentation backbone for three considerations: (1) it is lightweight and fast, (2) depth maps are directly obtained by the sensor when processing raw IR map, and (3) the smeared points generally deviate along the viewing ray, i.e. z-axis which indicates using a z-buffer is sufficient. The smeared classifier ψ maps an input ϕ={d, ω} consisting of a depth map and corresponding ray inner products, to an output consisting of the smeared probability p as:

$$Ψ : ϕ \to p \qquad ( 4 )$$

We use a binary cross-entropy loss function with the above self-generated geometric labels:

$$CE = - ( b + e ) \cdot log p - v \cdot log ( 1 - p ) \qquad ( 5 )$$

To balance both smeared and valid points, weights based on geometric label results are used here as Eq. (6).

$${w}_{k} = 1 - \frac{{‖ k ‖}_{0}}{{‖ v ‖}_{0} + {‖ b ‖}_{0} + {‖ e ‖}_{0}} , k ∈ \{ b , e , v \} \qquad ( 6 )$$

Besides, the confidence score c for the valid label is also considered to improve robustness as Eq. (7)

$$L = - α \cdot ( {w}_{b} b + {w}_{e} e ) log p - β \cdot {cw}_{v} v log ( 1 - p ) \qquad ( 7 )$$

In the above final loss equation Eq. 7, α and β are two hyper-parameters for fine-tuning in the experiment sections below.

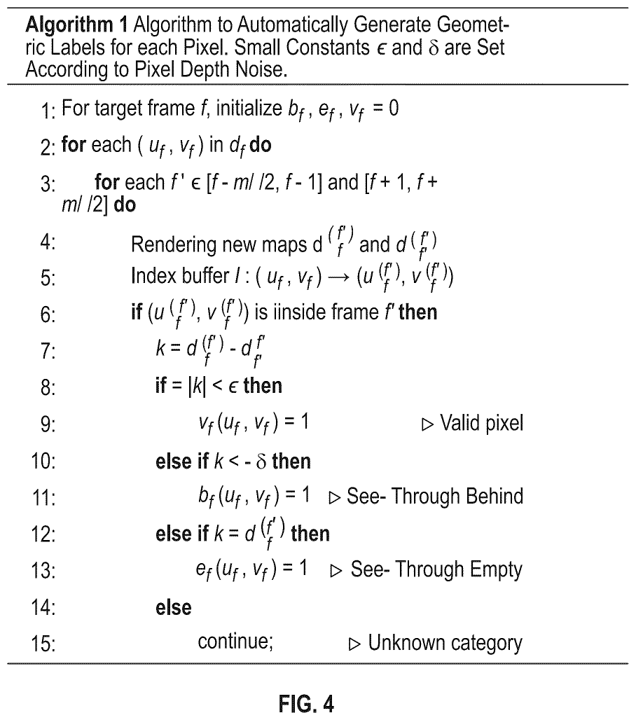

Referring now to FIG. 6, to validate the effectiveness of the method set forth herein, the real scene datasets using Azure Kinect were collected: a total of 50 indoor and outdoor scenes were captured using the Azure Kinect sensor, one of the state-of-the-art consumer-level cameras in the market. For each scene, the shooting time was 5 to 10 seconds with the hand-held camera moving without any speed or direction restraint under 5 HZ operation frequency. And then a total of 1936 pairs of depth and color frames of real scenes are captured. Like some published datasets such as NYU Depth V2, AVD, GMU Kitchen, etc, the presently developed dataset provides pairs of color and depth information sharing the same resolution (1920×1080), as shown in FIG. 62, by transforming depth image to the color camera and doesn't hurt raw frame contents. Raw depth maps with resolution 640×576 are provided. Since there are currently no depth sensors on the market that can effectively avoid smeared points, manually annotating 11 typical frames for 11 different scenes respectively was performed to get ground truth (GT). To ensure the accuracy of the annotation, human annotators are required to carefully observe the whole video clip for each test scene and modify GT labels several times repeatedly, which results in a single depth frame costing a human annotator about 6 hours. It is believed that, the AzureKinect dataset exceeds existing published real ToF datasets in both size and resolution and is the only dataset provided with pose information for different views of the same scene. Therefore, the dataset determined herein lays a good foundation for future work on this new problem though the test set is admittedly small in size.

Deep learning models from similar tasks: multi-path interference removal (DeepToF), image semantic segmentation (UNet DeepLabV3+, Seg-former, are used as the removal backbones based on the present self-annotated framework. The self-annotated method DeepDD for removing regular point cloud noises was adapted to this task by replacing pre-calibrated 4 cameras with every 4 consecutive frames with known pre-computed poses. Besides, 5×5 median filter based on the depth map and statistical filter based on point cloud are also included in the experiments. Those models and methods were evaluated based on the Mean Average Precision where the smeared class is considered positive, and the valid point is set as negative. For qualitative comparisons different from others, the predicted results are converted to the point cloud using an intrinsic matrix where smeared points are colored red while the valid points are colored green.

As mentioned, the geometric labels are first built when joining the off-the-shelf semantic segmentation network. A SoftMax layer in the classifier is added to adapt to the segmentation task and ResNet-34 is used as the backbone for UNet, DeepLabV3+, and Seg-former. All codes were implemented by Pytorch and all input frames and labels are cropped and resampled to 512×512 for computational needs by using nearest-neighbor interpolation to avoid creating artifacts. Augmentation is performed through random cropping to 128×128 with random rotation. The mini-batch Adam optimization algorithm, with a weight decay 1e-7, and run 200 epochs with a batch size 32. The initial learning rate is set at 1e-4 and reduced by 10 times after every 25 epochs with a 100-step cosine annealing schedule. The values α=0.3, β=0.7, ϵ=4 mm, δ=15 mm=were set in the experiments. The used adjacent reference frame number is m=4.

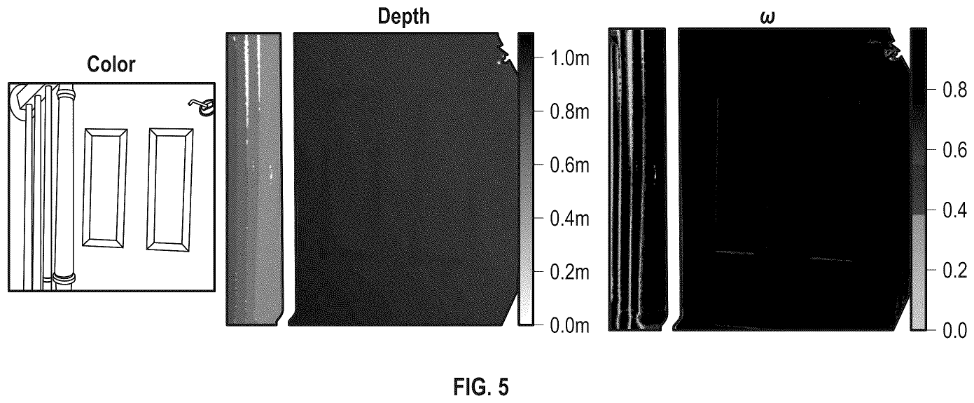

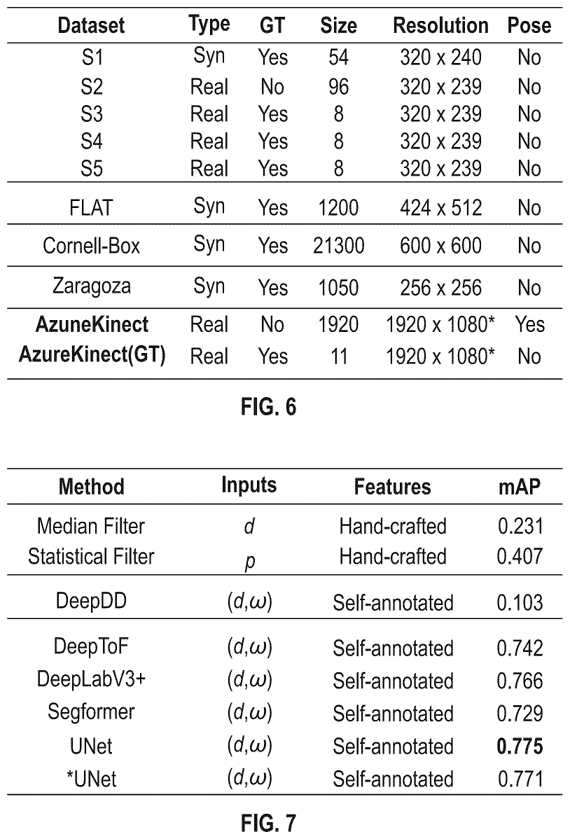

Referring now to FIGS. 7 and 8, to obtain pose information, multiview ICP with five-neighboring point clouds automatically aligns points and determines camera poses. For the DeepDD model which is a regression model compared to the segmentation task, we apply the threshold standard to get evaluation scores by computing abstract differences between the restored depth and raw depth. If the difference is smaller than the Azure Kinect's systematic error threshold (11 mm+0.1% d), then the depth pixel location is predicted valid, otherwise (larger than that threshold) smeared. Five cases of the test dataset are shown in FIG. 8, where the self-annotated UNet can detect most of the smeared points than the statistical filter though more valid points are misclassified as the distance increase and it is also challenging for a deep learning remover to detect these smeared points which share the similar structures as valid points, observed in the last row of FIG. 8. Eleven different depth maps were evaluated from 11 different scenes, where the model using UNet achieves the highest mAP compared to other methods, see FIG. 7. Besides, using uniform weighting (c=1) for multi-view annotation reduces the mAP by 4% than the confidence score design in Eq. (1). The failure of the self-supervised method DeepDD is also noticed in the experiment, where both the consecutive frames with close viewings, and similar color information among the same observed structures impede this method's effectiveness.

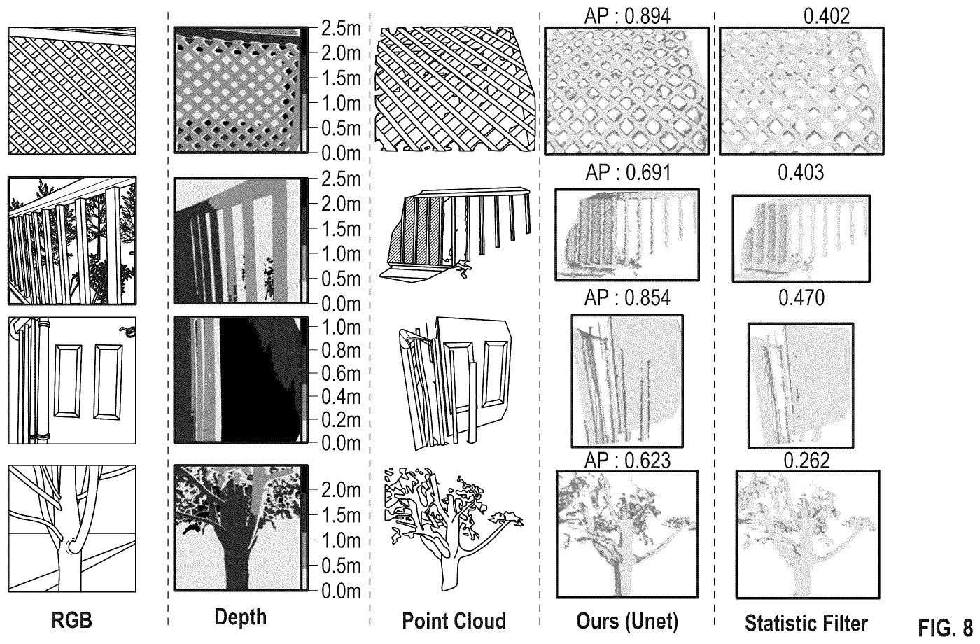

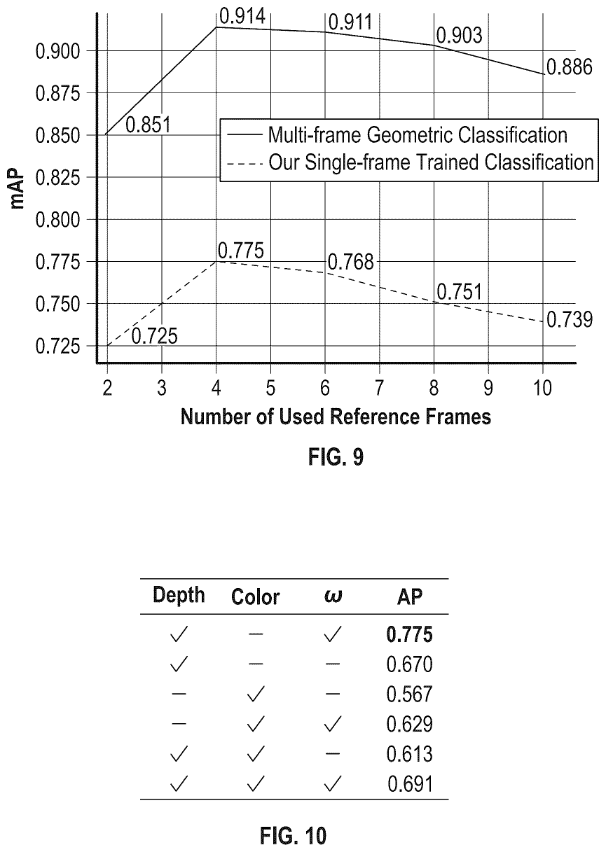

To identify the optimal number of consecutive reference frames required, the experiments were with different self-annotated labels for partial points, each derived from different numbers of reference frames. We also generate such labels for the test set to ascertain the accuracy of the present geometry annotation. Both evaluations on multi-frame geometric classification and the single-frame trained classification are concluded as in FIG. 9. Geometry labels for partial points exhibit 12%-15% higher mAP than UNet for all points, affirming the precision of the self-annotated labels for partial points. Moreover, using more frames doesn't feed better labels back since the pose estimation is less accurate for long-distance frames and the contradictory information from different frames stands out which further prevents predicted improvements when using more frames.

To validate the selection for input modality ϕ, the remover's input is replaced with multiple different combinations of color, depth, and normal-view map ω and evaluate it after 100 training epochs (all convergence guaranteed). For a fair comparison, a hyperparameter search was for each kind of input modality ϕ and report results in the Table of FIG. 9 which shows that the ω map helps detect smeared points both for depth map and color map with a large increase. Besides, indicated by the drop in performance, the coloration in the ages contain some invalid information from similar visual features and produce disturbances.

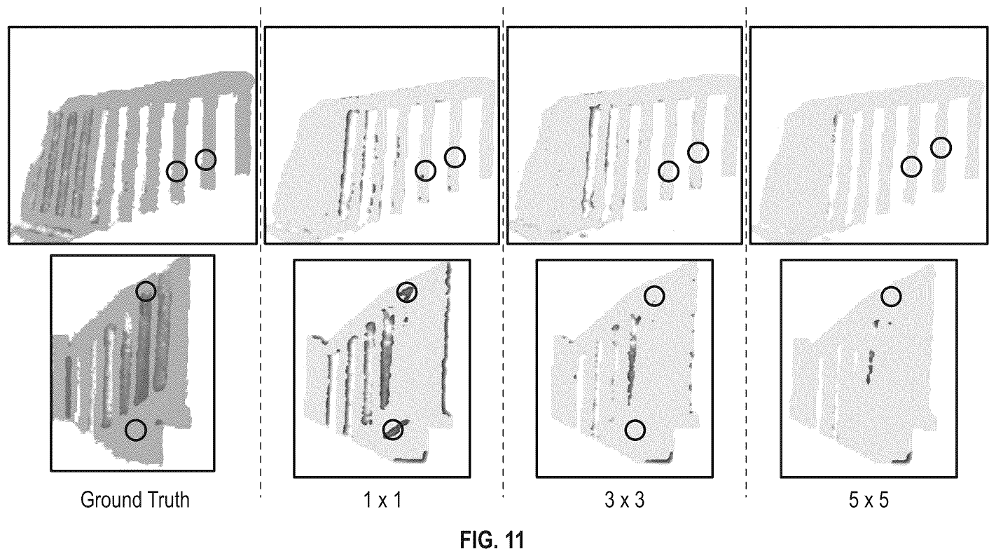

To validate the choice for the sliding window size φ=3×3 in reducing unconfident self-annotated smeared labels in See-Through Empty, different kernel sizes are applied as shown in FIG. 11 for the qualitative comparisons. When φ=1×1, it is equivalent not to filter any self-annotated smeared points from See-through Empty. Both 3×3 and 5×5 effectively avoid some misclassifications, but the sliding window with size 3×3 can keep more confident smeared labels than that of 5×5. With Φ>5×5, too few smeared points are expected to be detected. Therefore, the selection for the sliding window is based on a trade-off assessment of self-annotated label quality and quantity.

FIG. 11 shows qualitative comparison among different sliding window sizes for reducing unconfident labels from See-through Empty. The remaining smeared points are shaded differently. Misclassifications are reduced and can be seen in small circles.

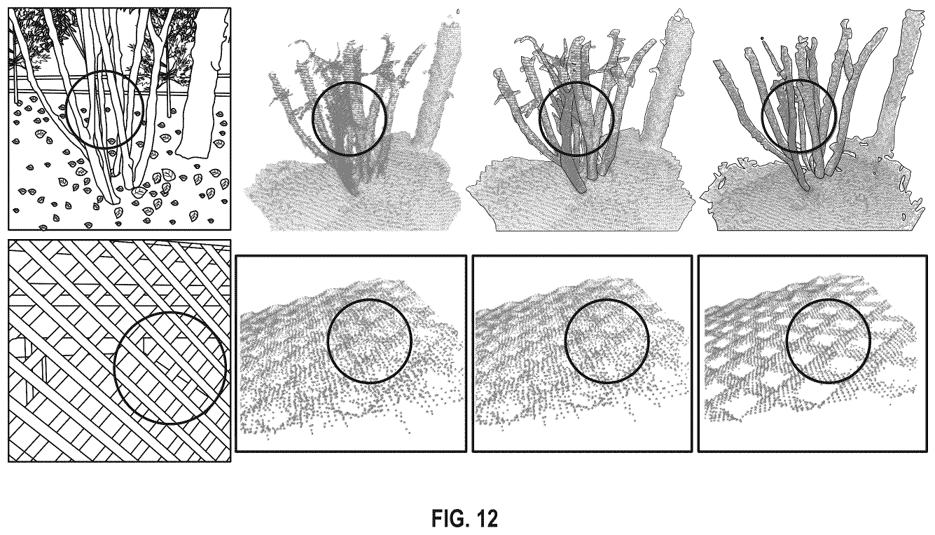

It is always a major challenge to reconstruct objects with sophisticated fine-grained structures using consumer-level cameras. A related experiment in FIG. 12 aligns 15 consecutive frames under the 5 HZ work frequency of an Azure Kinect depth sensor and uses down-sampling to make a number of point clouds consistent with three different pre-processes: without any filtering, adding a statistic outliers filter, or using trained UNet model as a preprocessor. Qualitative result in FIG. 12 shows that the trained removal better helps align and keep high-fidelity 3D point clouds relieved of smeared points when placed as a preprocessor.

In FIG. 12 results of multiple frames alignments using the trained network Is set forth. From the left column to the right, the second column is the aligned point cloud without any filtering; the third column is the aligned point cloud adding an outlier filter; the last column is using the present network as a preprocessor for the raw depth map.

The present disclosure sets forth a self-annotated architecture to detect smeared points and then remove this harmful artifact from consumer depth sensors. Visibility-based evidence is automatically gathered from multiple viewpoints of a hand-held sensor to annotate depth pixels as smeared, valid or unknown. These annotations are used to train the smeared point detector with no need for manual supervision. Being self-annotated avoids the need for costly human annotation while enabling simple data collection and training of widely varied scenes. As a low-computational network, it can be used as a preprocessor for every single raw frame to improve the quality of 3D reconstruction.

The forgoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the term “and/or” includes any and all combinations of one or more of the associated listed items.

What is claimed is:

1. A method comprising:
obtaining a plurality of training images of a scene from different poses from at least one imaging device;
forming a point cloud of the scene having a plurality of pixels of each training image and a depth;
rendering a first pixel in a first reference frame to a second reference frame, said first reference frame comprising a first depth and the second reference frame comprising a second depth;
comparing a depth difference of the first depth and the second depth;
determining whether the pixel is valid or smeared based on the depth difference;
associating a label with the pixel corresponding to valid or smeared;
training a classifier with the pixel and the label to form a trained classifier;
obtaining an image to be classified at the classifier and classifying the pixels in the image as valid or smeared; and
removing smeared pixels from the image to form a cleaned image.

2. The method of claim 1 further comprising communicating the cleaned image to a display and displaying the cleaned image.

3. The method of claim 1 wherein the plurality of images includes the first pixel generated from a first pose of an imaging device and the first pixel in a second pose of the imaging device.

4. The method of claim 1 wherein when the depth difference is about zero, determining the first pixel is valid.

5. The method of claim 1 wherein when the depth difference is less than a negative threshold, determining the first pixel is valid.

6. The method of claim 1 wherein when the depth difference is less than a negative delta, determining the first pixel is smeared by a see-through behind determination.

7. The method of claim 1 wherein when the depth difference is the depth determining the first pixel is smeared by a see-through empty determination.

8. The method of claim 1 further comprising determining a surface normal of the first pixel, and training the classifier with the surface normal.

9. The method of claim 1 wherein rendering the first pixel in a first rendered frame of reference comprises determining a rendered depth and a rendered position coordinate.

10. A method for removing smear points in image processing comprising:
obtaining a plurality of images of a scene from different poses of an imaging device, wherein the plurality of images has a plurality of pixels;
determining whether each of the pixels is valid or smeared based on multi-viewpoint evidence;
annotating a valid label or smeared label to each of the pixels to form an annotated training set based on determining whether each of the pixels is valid or smeared;
training a classifier with the annotated training set to form a trained classifier;
communicating an image to classify to the trained classifier;
classifying the pixels in the image as valid or smeared; and
removing smeared pixels from the image to form a cleaned image.

11. The method of claim 10 wherein determining whether of each of the pixels based on multi-viewpoint evidence is valid or smeared comprises determining a depth difference of each of the pixels from two different positions of an imaging device.

12. The method of claim 10 wherein determining whether of each of the pixels based on multi-viewpoint evidence is valid or smeared comprises determining validity of each of the pixels based on observing a pixel from a first viewpoint and a second viewpoint separated from the first viewpoint by an angle less than ninety degrees.

13. A system comprising:
at least one imaging device generating a plurality of images of a scene from different poses;
a pixel annotator forming a point cloud of the scene having a plurality of pixels of each image and a depth, the pixel annotator rendering a first pixel in a first reference frame to a second reference frame, the first reference frame comprising a first depth and the second reference frame comprising a second depth;
the pixel annotator comparing a depth difference of the first depth and the second depth, determining whether the pixel is valid or smeared based on the depth difference, associating a label with the pixel corresponding to valid or smeared;
a trained classifier trained by with the pixel and the label to form a trained classifier, the trained classifier obtaining an image to be classified and classifying the pixels in the image as valid or smeared and removing smeared pixels from the image to form a cleaned image.

14. The system of claim 13 further comprising a display displaying the cleaned image.

15. The system of claim 13 wherein the plurality of images includes the first pixel generated from a first pose of an imaging device and the first pixel in a second pose of the imaging device.

16. The system of claim 13 wherein the pixel annotator determines the first pixel is valid when the depth difference is about zero.

17. The method of claim 1 wherein when the depth difference is less than a negative threshold, determining the first pixel is valid.

18. The system of claim 13 wherein the pixel annotator determines the first pixel is smeared by a see-through behind determination when the depth difference is less than a negative delta.

19. The system of claim 13 wherein the pixel annotator determines the first pixel is smeared by a see-through empty determination.

20. The system of claim 13 wherein the pixel annotator determines a surface normal of the first pixel, and wherein the trainer trains the neural network with the surface normal.
